(19) United States
(12) Patent Application Publication
(10) Pub. No.: US 2006/0130128 A1
(43) Pub. Date: Jun. 15, 2006

(54) Process for compiling and executing software applications in a multi-processor environment

(76) Inventors: Emir Gorancic, Mandal (NO); Ulf Carlsen, Mandal (NO); Hakon Hammerstad, Mandal (NO)

Correspondence Address: WENDEROTH, LIND & PONACK, L.L.P., 2033 K STREET N. W., SUITE 800, WASHINGTON, DC, 20006-1021, US

(21) Appl. No.: 10/519,489

(22) PCT Filed: May 22, 2003
(86) PCT No.: PCT/NO03/00167

§ 371 Date: Oct. 26, 2005

(30) Foreign Application Priority Data
Jul. 1, 2002 (NO) 20023194

(51) Int. Cl. H04L 9/32

(52) U.S. Cl. 726/9

(57) ABSTRACT

The present invention relates to multi-application, secure operating systems for small, secure devices, such as smart card microcontrollers. In particular, the present invention relates to mechanisms for secure runtime upload of applications onto small devices, authorisation mechanisms and the ability for authorised execution of multiple applications on the devices, where an application may be potentially larger than the microcontroller memory size. The mechanism simplifies life-cycle smart card management aspects related to post-issuance application (“applet”) upload and upgrade. Mechanisms to prepare applications (i.e. compiler techniques) using a common set of project files in one compiler toolset, for execution in a dual host & chip processor environment are described. These help automising the programming of the communication interfaces between the host and chip applications. An important motivation for the present invention is to provide a secure co-processor environment for general computer applications in order to counter software piracy, and to allow new models for secure electronic software distribution and software licensing.

### BACKGROUND

The present invention relates to multi-application, secure operating systems for small, secure, external devices, such as smart card microcontrollers (“chips”). In particular, the present invention relates to mechanisms for secure runtime upload of applications onto such devices, authorisation mechanisms and the ability for authorised execution of multiple applications on the devices, where an application may be potentially larger than the microcontroller memory size. The mechanism simplifies life-cycle smart card management aspects related to post-issuance chip application (“applet”) upload and upgrade complexity. Also, mechanisms to prepare applications (i.e. compiler techniques) using a common set of project files in one compiler toolset, for execution in a multi-processor host & chip environment, are described, thus automising the programming of the communication interfaces between the host and chip applications. An important motivation for the present invention is to provide a secure co-processor environment for general computer applications in order to counter software piracy, with accompanying development tools, and to allow new models for secure electronic software distribution and software licensing. The present invention relates to U.S. Pat. No. 6,266,416, which is incorporated by reference herein. This patent describes a system for software license protection through the partial execution of a software application in a tamper-resistant external device.

A number of technological challenges appear when a software application must be split and executed on multiple processors, e.g. on a host computer workstation and an external token such as a smart card (chip card) microcontroller: The host application needs to be able to call functions residing on the token. Different variables now reside both on the host processor and the token. All functions which operate on (secure) variables residing on the token need to be executed on the token. Variables need to be exchanged in both directions when (and only when) required.

All such runtime features which govern dual-processor execution need to be supported by development tools. Software protection is often an ad-hoc, post-development task. Therefore, the developer needs a simple and user friendly set of tools to determine what functions (or parts of code) to execute on the token, what programming variables shall reside on the token and what functions and programme variables shall reside on the host. The development tool needs to handle all protection aspects including usage of cryptographic algorithms. It should hide all low level communication protocol details from the developer, so that he/she does not have to care about design of PDUs (Programming Data Units) and hardware interface communication protocol programming.

Furthermore, the code executing on the token must be token hardware independent. Device-independent execution implies the availability of virtual machines and accompanying development compiler tools.

External devices in general do not have the same performance capacity as ordinary host processors. The more code which can be put onto the external device the better the security gets. Therefore, the solution must allow repeated and simple try-and-fail tuning of the protection by the developer in order to maximize performance and security.

The memory of a conventional smart card may be preloaded with a smart card application (commonly called applet). Java card(TM) is a smart card operating system defined by Sun Microsystems that is able to interpret a applets containing Java byte code. A Java card may store multiple applets which have different functionality. In many conventional smart cards, the applets are preinstalled into ROM and remain on the card forever. However, many smart card operating systems, including Java card, include means for uploading and storing applets in EEPROM, where applets may later be deleted. Other conventional smart cards include MULTOS and Smart Card for Windows.

U.S. Pat. No. 5,923,884 (Peyret et al.) discloses a smart card that can store an entire application, including use rights, in its memory. In this smart card, the application is disposable. That is, the application can be removed once it is depleted, and can be replaced by a new applet. One suitable application for loading onto this smart card is a prepaid telephone time applet. Upon depletion of the time, a new applet with replenished use rights may be loaded to recharge the smart card. Alternatively, a completely different applet may be loaded.

Despite the flexibility of conventional smart cards, there are still deficiencies in such smart cards. For example, the size of the applet that executes in the smart card is limited by the memory of the smart card, particularly, the size of the non-volatile memory, which is typically EEPROM. Although non-volatile memory size in smart card continues to increase every year, it would be desirable if there were no memory constraints imposed on the size of the applets. Also, since non-volatile memory is expensive, it would be desirable to be able to execute an applet on a smart card which has less non-volatile memory than the size of even a small applet.

Furthermore, conventional smart cards upload applets in a static manner. That is, the applets are loaded into the smart card either at production time (e.g., preinstallation of the applet into ROM), as illustrated in FIG. 1, or during a programming mode (e.g., scheme in U.S. Pat. No. 5,923,884 (Peyret et al.)). So far there have been no dispositions (and apparently no requirements) to allow applet management (upload and/or deletion) to occur at the very moment while the applet itself is executing. Also, there have been no mechanisms described which allow the upload of only parts of an applet at the time. In patent GB 2163577, entire applications are uploaded, not fragments or independently executable blocks of software code. Current applet loading processes require separate management software which increases the time, complexity and expense associated with smart card usage. Global Platform (www.globalplatform.org) defines such standards for smart card management, including applet loading and deletion, which have been implemented by Java cards.

The traditional approach to application programming for multiple processors, e.g. for smart card applications which always operate in connection with an external host of some kind, is to develop and compile one application separately for each processor (as shown in FIG. 7), taking care to define the communication interface between each processor very carefully. One problem with this traditional approach, is the necessity for application developers to carefully design (and at an early stage fix) the interfaces between the different processors. Currently there is no way a compiler operating on a smart card application alone, is able to modify programming interfaces between processors, without having the compiler for the host application doing the same modifications accordingly. In other words, in order to allow interfaces to be adapted and improved automatically by compiler tools, the compilers (or compiler) need(s) to operate on both the host application source code and the smart card application source code simultaneously. However, in order for one compiler to operate simultaneously on two (or multiple) applications, the compiler needs to obtain information about what parts of the software application code belong to what processor platform. The present invention addresses these issues, and enables developer-friendly implementation of multiple-processor applications where the low-level PDU (Programming Data Unit) protocol implementational details are taken care of automatically by the compiler, and thus hidden for the developer.

### SUMMARY OF THE INVENTION

To simplify applet management aspects it would be desirable if applets could be uploaded dynamically, at runtime, and without using separate management software. The present invention fulfils such unmet needs by allowing an applet to be transferred to an external unit (e.g., a smart card) for execution in the external unit at runtime without using separate management software, and by allowing the applet to be transferred to the smart card and executed in the smart card in sequentially transferred blocks of code, hereafter also referred as “QX blocks”. (“QX” stems from the name of a smart card operating system developed by Sospita, and is an abbreviation for “seQure execution”.)

The present invention allows for execution of software code of a software program on an external unit. The external unit is connected to a computer. The computer includes memory for holding the software code. The external unit includes input/output for communication with the computer, a processor, and memory.

At runtime of the software code, the software code is automatically uploaded to the memory of the external unit. The software code is then executed in the external unit using only the processor and the memory of the external unit.

In an additional feature of the present invention, the software code is arranged or parsed into a plurality of different blocks of code, wherein each block of code is independently executable. In this embodiment of the present invention, a first block of code required for execution is automatically uploaded to the memory of the external unit. Next, the first block of code is executed in the external unit using only the processor and the memory of the external unit. When required, subsequent blocks of code of the software code are then sequentially and automatically uploaded and executed in the external unit. During this process, subsequent blocks of code overwrite previously uploaded blocks of code in the memory of the external unit if this is required to have enough memory in the external unit for the subsequent blocks of code.

In one preferred embodiment of the present invention, the software code is an applet, and each of the different blocks of code are QX blocks. The software program may include a plurality of applets interspersed within the software program. The process described above is applied to each applet.

In another preferred embodiment of the present invention, the software code includes a first portion and a second portion. The second portion is the software code that is executed in the external unit, and the first portion executes in the computer. After execution of the software code, the external unit sends back state information to the computer for subsequent use by at least the first portion of the software code.

The software code that executes in the external unit is preferably encrypted. If so, then each block of code must be decrypted in the external unit prior to execution.

The external unit is preferably a tamper-proof device, such as a smart card, USB token, PC card, a TEMPEST/tamper-protected workstation or a physically secured computer server connected to a network.

Compiler development techniques are presented that allow one set of files to contain code both for the host application and for the chip application. Source code for a particular target processor is tagged, and during compilation transformed into encrypted (virtual) machine code. The tagged blocks of code are replaced by function calls which refer to the encrypted (virtual) machine code components, to the effect of allowing these blocks of protected code to be dynamically loaded onto the remote processor during runtime, decrypted, stored and executed. The source code for a particular target processor is split into independently executing blocks of code, which allows the independent execution of each block of code, which in turn allows the target processor (with potentially limited available resources in terms of memory and CPU) to execute applications bigger than its available memory.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings an embodiment that is presently preferred. It should be understood, however, that the invention is not limited to the precise arrangements and instrumentalities shown. In the drawings:

FIG. 1: shows the prior art chip application upload and execution procedures. Applets are uploaded using a trusted application loader, prior to any execution of the applet itself or to the execution of its associated host application. Applets are typically loaded in secure sites before the smart cards are even issued, or within a secure site sometime after the smart card has been distributed to the customer. This procedure implies that the customer is required to bring his/her card to such a secure site in order to upgrade the card.

FIG. 2: shows a preferred embodiment of the present invention, whereby the applet, or even just a part of the applet, is allowed to be securely uploaded onto the remote processor.

FIGS. 3 and 4: show the same configuration as FIG. 2, but where time has elapsed and the remote processor contains state with regards to what applets and parts of applets are stored within.

FIG. 5: shows a function call graph, showing interdependencies between four software functions.

FIG. 6: shows the same function call graph as in FIG. 5, additionally illustrating transitive dependencies of arguments to each of the functions.

FIG. 7: shows prior art procedures for compiling multiple application for multiple processors using multiple compilers and development tools.

FIG. 8: shows a dual-step sequential compilation procedure which allows one set of source files to be used to contain application code for multiple processors, and which allows the resulting executable of the same source files to embed (encrypted) runtime uploadable application code for each of the multiple processors.

FIG. 9: Shows the advantage of incorporating tags as comment fields of traditional compilers, whereby traditional compilers can be used to generate code for simulation and debugging purposes.

FIG. 10: shows an ANSI C programming language source code examples, where tags which identify processor code for a second processor have been incorporated.

FIG. 11: shows the same code example of FIG. 10, after compilation for the second processor. Notice that the code is still ANSI C programming language source code.

FIG. 12: describes a cryptographic protocol for the secure transfer for a license (or a capability) from one secure processor to another, in a fashion which prevents duplication or piracy of the license.

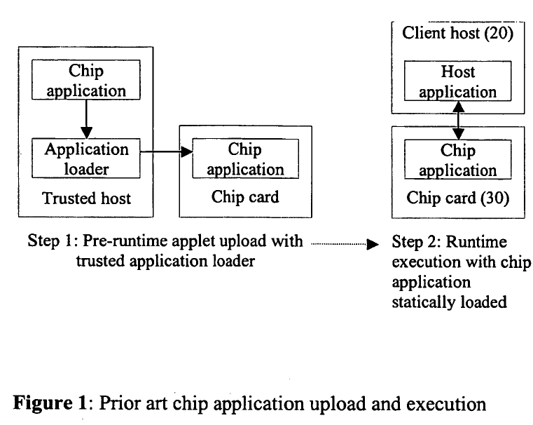

### DETAILED DESCRIPTION OF THE INVENTION

Certain terminology is used herein for convenience only and is not to be taken as a limitation on the present invention. In the drawings, the same reference letters are employed for designating the same elements throughout the several figures.

The present invention describes a mechanism in which chip applications (applets) are dynamically uploaded to the smart card during runtime, i.e. during the actual execution of the application itself. In effect, the chip application is bootstrapping itself potentially every time it, together with its corresponding host application, is executed. This approach is substantially different from all other smart card operating systems, where the smart card application is loaded onto the smart card in the production or post-production phase, but always before the execution of the actual chip application starts.

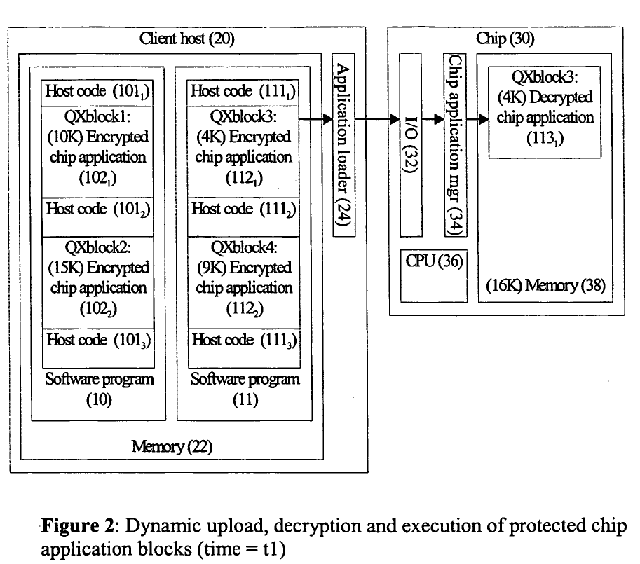

FIG. 2 shows one preferred embodiment of the present invention. Computer includes a memory 22 that contains software programs 10 and 11. The software program 10 includes a portion of unencrypted code 101 (i.e., the combined code labelled 101₁, 101₂ and 101₃) that executes on the computer 20. The software program 10 also includes chip application 102 (i.e. the combination of QX blocks 102₁ and 102₂). In this example, QX blocks 102₁ and 102₂ take up 10 Kilobytes and 15 Kilobytes memory respectively. Similarly, the software program 11 includes a portion of unencrypted code 111 (i.e., the combined code labelled 111₁, 111₂ and 111₃) that executes on the computer 20. The software program 11 also includes chip application 112 (i.e. the combination of QX blocks 112₁ and 112₂). In this example, QX blocks 112₁ and 112₂ take up 4 Kilobytes and 9 Kilobytes memory respectively.

FIG. 2 also shows an external unit 30 which is generally similar to the external units described above. The external unit includes CPU 36, input/output (I/O) 32, a chip application manager 34 and non-volatile memory 38, which usually is EEPROM, also might be flash memory or any other kind of memory, depending on the type of the external unit. The chip application manager 34 handles all management related to decryption and storage of chip applications and chip application blocks, before and during chip application runtime.

The application loader 24 and chip application (applet) manager 34 implements mechanisms to allow dynamic, runtime applet upload into the chip OS. As described above, each chip application is composed of a number of distinctly identifiable blocks (QX blocks). Every time a new QX block is to be executed, the application loader sends a request to the applet manager. In one embodiment of the present invention, the chip application manager first verifies that it contains a valid license for this QX block. If the license is valid, the applet manager continues to check if there is enough memory to store the QX block. If there is not enough space left, the applet manager selects “old” QX blocks which are allowed to be deleted, which collectively free enough space for the new QX block to be stored. The new QX block, which originally was stored encrypted inside the host executables, is transferred to the token, decrypted, its integrity verified, stored in memory and then finally it is invoked. This dynamic, runtime approach to applet management has several important advantages:

Smart card memory is no longer reserved for one application, but can be shared between all applets which associate with a valid license on the token. The memory is thus reused by multiple applets, allowing execution of more applets than there would otherwise be room for in the smart card memory.

Because the applet manager operates on QX blocks, and not just entire QX applets, the applet manager even allows one single QX applet which in itself is bigger than the available EEPROM to still be executed in the token.

Host executable files which embed QX applets provide an ideal storage and transport container for seamless and cost-efficient distribution of new applets as well as for applet upgrades, thus solving a majority of the expensive logistics of chip application lifecycle maintenance.

In the example of FIGS. 2, 3 and 4, the chip memory 38 has 16 Kilobytes total of memory. In conventional smart card implementations the external unit 30 would not be capable of executing both chip application 102 or 112 together, because the total size of the chip applications (10K+15K=25K for chip application 102 and 4K+9K=13K for chip application 112) exceeds the size of the memory 38 (16K). Furthermore, conventional smart card implementations the external unit 30 would not be capable of executing chip application 102 on its own, because the total size of chip application 102 (25K) alone exceeds the size of the memory 38 (16K).

The present invention provides a solution to this limitation. At compilation time, each block of code is independently executable. During execution of software program 11 in FIG. 2 (at time t=1), QX block 112₂ is transferred by the application loader 24 to the external unit 30. QX block 112₂ is decrypted and stored as a decrypted QX block 113₁ in memory 38. Because each block of code is independently executable, QX block 112₂ is allowed to be executed by the CPU 36. In another embodiment (not shown in the figure), QX block 112₂ is stored directly into memory 38, without decryption. In yet another embodiment (not shown in figure), the Chip 30, upon reception of QX block 112₂, first verifies if it contains a capability to decrypt and execute this chip application. If so, QX block 112₂ is decrypted and stored as a decrypted QX block 113₁ in memory 38, and then executed by the CPU 36.

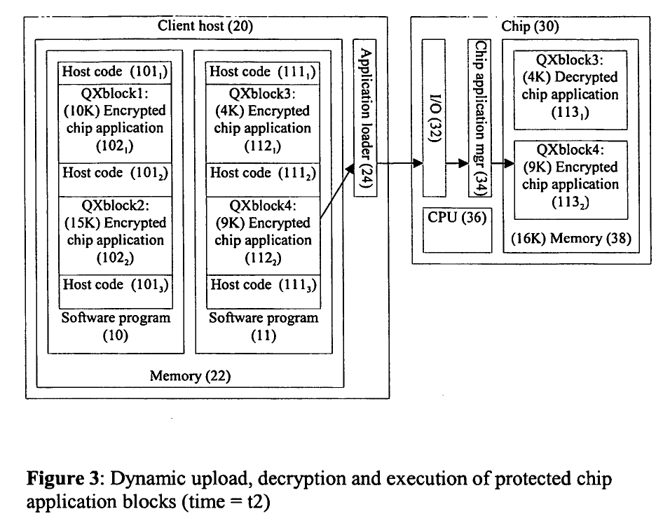

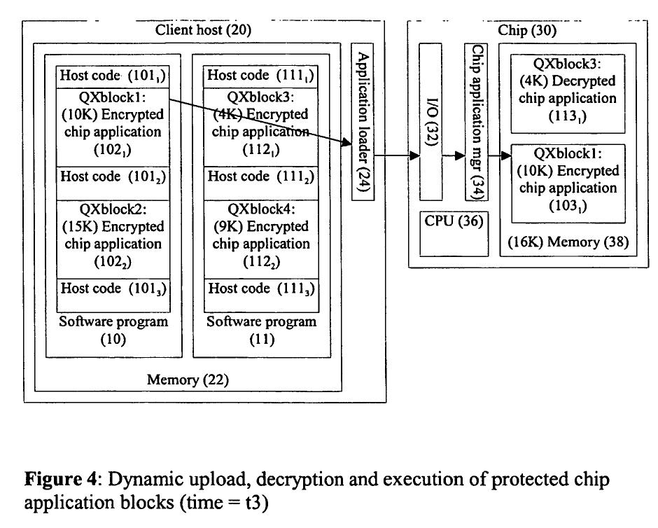

At time t=2 during execution, QX block 112₂ needs to be executed. FIG. 3 illustrates this scenario. Since memory 38 contains enough free space, QX block 112₂ is dynamically uploaded and stored together with the first QX block 112₁. Provided the chip memory 38 is large enough then in an alternative embodiment of FIGS. 2 and 3, QX block 112₁ and QX block 112₂ could be loaded onto the smart card memory at the same time t=1, just when the first QX block starts execution. At time t=3 during execution, the execution path of the software program reaches QX block 102₁, either because the host code 101 reaches here or because the chip application 102 does. If the chip application does, it sends a request to the application loader 24 to instruct it to initiate upload of the new QX block. Now in either case the client host 20 sends a request to the chip 30 to initiate upload of the new QX block. The chip application manager 34 recognises that QX block 102₁ occupies 10 Kilobytes memory, while the chip memory 38 is virtually full. In order to allow upload and execution of QX block 102₁, the chip application manager 34 frees memory by deleting some of the QX blocks already stored on memory 38. In FIG. 4 the chip manager 34 determines that it is sufficient to delete QX block 103₁. It is deleted, and the new QX block 102₁ is uploaded to the chip, decrypted, stored and executed. Notice that in this scenario, both chip applications 102 and 112 are allowed to be active at the same time on the chip 30. Chip application 102 is at any time allowed to re-upload any QX blocks that are not present.

Before deleting a QX block, the applet manager 34 needs to determine what QX block or blocks to delete. Common deletion strategies exist for different systems, including selecting the “best fit” object memory size and required memory size, the least-used object or the least-recently-used object. In one embodiment of the present invention, each QX block may incorporate a “delete mode” attribute. The applet manager uses the attribute to determine what QX block(s) to delete next. Four delete levels are offered:

1) Delete on close: The QX block is automatically deleted every time the QX applet terminates.

2) Keep on card; delete by anybody: After upload and execution the QX block remains on card until the applet manager, invoked by any QX applet, decides to remove it.

3) Keep on card; delete by self only: After upload and execution the QX block remains on card until the applet manager, invoked by another QX block that belongs to the same QX applet, decides to remove it.

4) Keep on card: In this case the QX block is never deleted, unless perhaps by an authenticated request, e.g. using passwords. The password is set by the applet issuer, so normally only the issuer is able to delete the applet. This delete mode resembles the traditional approach followed by Java cards, where applets are stored more or less statically on the card.

The mechanism for dynamic, runtime upload of QX blocks for multiple applets is repeated for any subsequent QX blocks until all QX blocks and all chip applications have been executed. Any resulting state parameter after execution of a QX block is stored in the chip memory 38 or returned to the software program 22 for subsequent use by the software application.

As discussed above, one significant benefit of the present invention is that the software code to be executed in the external unit 30 is not constrained by the size of the memory 38 in the external unit 30. If an application program has a 50K applet, there can be ten sequential transfers of 5K of code. Other examples are within the scope of the present invention.

Software development for multiple processors is made complex due to the multiple communication interfaces which appear, threads of execution may be complex if concurrent programming is introduced etc. It is therefore of importance to develop automated tools to assist development as far as possible. Consider the following scenario: When software programs are executed in multiple processors, different parts of the software program are allocated to be executed on a specific processor. Furthermore, different program variables are allocated to be stored on various, specific processors. E.g., in a dual processor environment with two processors “host” and “chip”, the host application may call the chip function Func1(A). The parameter A is passed as a function argument from the host to the chip. Assume that the parameters A and B reside on the host, and assume that Func1(A) currently executing on the chip needs to call Func2(B). Now, even if both functions Func1(A) and Func2(B) are present on the chip, then because B only resides on the host, the chip operating system needs to send a request back to the host, for the host to transmit parameter B to the chip. This procedure has several disadvantages. From a security perspective information is revealed when the chip suddenly requests a new parameter. From a performance point of view, the communication between the chip and the host may be slow.

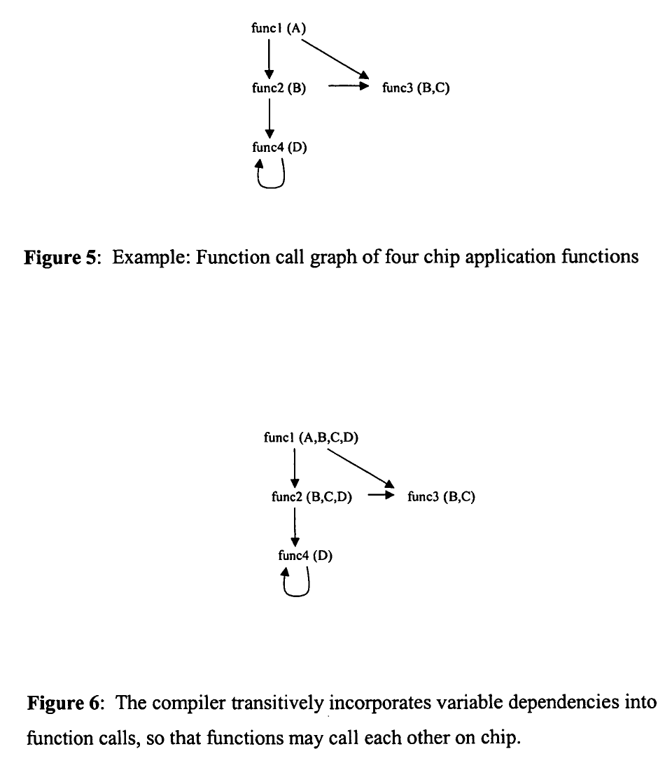

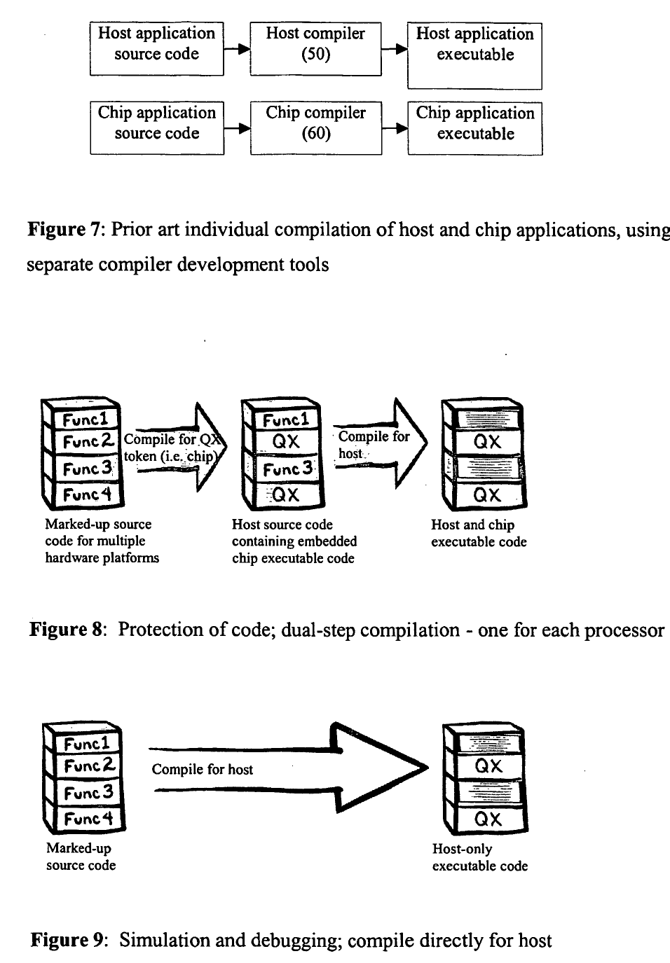

To amend the situation described above, Func1(A) could be redefined into Func1(A,B). In this way the chip is sure to always receive both parameter A and B when Func1 is called. Hence, if and when Func1 requires to call Func2, parameter B will be present. FIGS. 5 and 6 illustrate a similar case. In FIG. 5, four functions Func1(A), Func2(B), Func3(B,C) and Func4(D) and their call pattern is shown. FIG. 6 shows the transformed functions: Since Func2 calls Func3 and Func4, Func2 needs to incorporate parameters for Func3 and Func4. I.e. Func2(B) is transformed into Func2(B,C,D). Similarly, Func1 calls Func2 and Func3, so Func1(A) is transformed into Func1(A,B,C,D). Func3( ) calls no other functions, so no transformation is required. FuncD calls itself recursively. Since recursion does not add any new arguments, FuncD needs no transformation.

The task of redefining functions can be done manually by developers. This may be a tedious task, so the ideal solution is to let development tools, e.g. compilers, do the work automatically.

The traditional approach to program an application for multiple processors, e.g. for smart card applications which always operate in connection with an external host of some kind, is to develop one application separately for each processor, taking care to define the communication interface between each processor very carefully. One problem with this traditional approach, is exactly related to the problem above: There is no way a compiler operating on a smart card application alone, can (or even should) be able to modify the function interfaces, without having the compiler for the host application doing the same modifications accordingly. In other words, in order to allow interfaces to be adapted and improved automatically by compiler tools, the compilers (or compiler) need(s) to operate on both the host application source code and the smart card application source code simultaneously. However, in order for one compiler to operate simultaneously on two (or multiple) applications, the compiler needs to obtain information about what parts of the software application code belong to what processor platform. One solution could be to keep code for the different platforms in different files, and tell the compiler what files belong to what processor. This solution works fairly well, but is not optimal because the logical structure of the application is obscured when functions which belong together from a logical point of view are forcedly split apart to enable the compiler to associate the code with a particular platform.

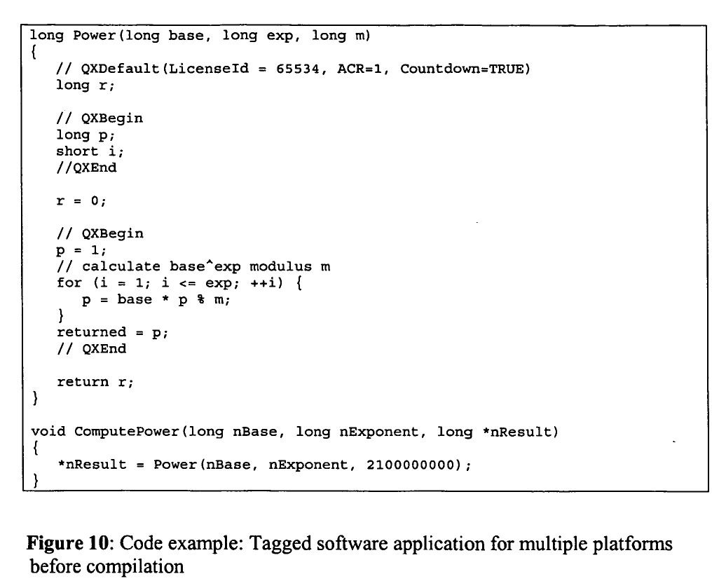

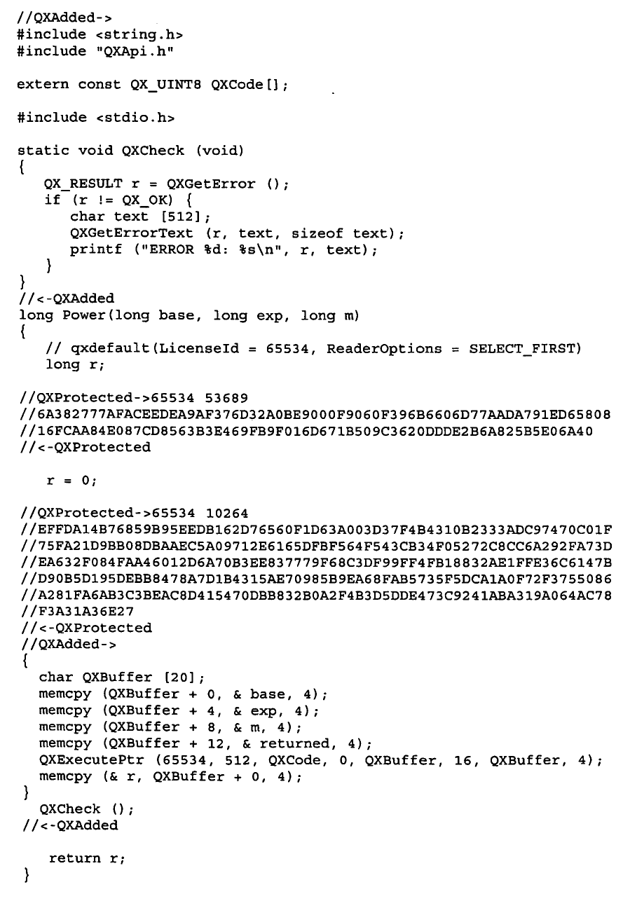

An intelligent way to distinguish one code from the other. is to provide syntactical means to identify and mark up code for the various platforms. Recalling from above that a chip application (an applet) is divided into functionally independent QX blocks, a pair of uniquely identifiable keywords, e.g. QXBegin and QXEnd, can be used to mark the beginning and the end of one QX block. The keywords may be used repeatedly, so that in principle each new marked portion of the code constitutes a new unique QX block. The sum af all marked QX blocks constitutes the applet, or the chip application. All code which is not marked, i.e. all the “negative” blocks of code (from QXEnd to QXBegin), constitute the host application. The markup language can trivially be extended for multiple (more than 2) application platforms, or blocks, of code that collectively constitute the applet. Every QX block is allocated a unique QXBlockId. FIG. 10 illustrates the principle of marking up a software program for two processors; host and (smart card) chip. All code which is present between QXBegin and QXEnd is allocated for chip execution.

A QX block is comparable to a Java card method. One significant difference between a Java card method and the QX blocks illustrated in FIG. 10, are that Java card methods (and the entire Java card application) never is contained together with the host application code. Another important difference is that a QX block need not be an entire function. In fact, FIG. 10 shows two QX blocks, neither of which is a definition of an entire function. In other words, there is nothing which restricts marked-up code (QX blocks) from being anything from a single-line statement, to multiple statements within a function (e.g. an ANSI C block, as determined by curvy brackets “{” and “}”, to an entire (non-object-oriented) function or (object oriented) method. In a preferred embodiment where QXBegin-QXEnd encompass more than one entire function, one QX block for each function will be generated by the compiler.

Since the un-marked and the marked code are intended for execution on different hardware platforms, it is very likely that these hardware platforms offer different services, instruction sets, function libraries and other capabilities. In this case the compiler will need two (or multiple) different code generators, one for each different hardware platform. Alternatively, two (or multiple) different compilers can be devised and used so that the output from one compiler is input to the next compiler. I.e. compilers are linked together in sequence. In order to achieve this it is vital that the output format of one compiler corresponds to the input format of the next compiler. In practice, if a multi-platform software application is written in one programming language (such as ANSI C or Java), this suggests that the input format should be equal to the output format. We end up with compilers that, for instance, “translate” source code from ANSI C “into” ANSI C.

FIG. 8 shows such a multi-compiler environment, with two compilers, one which compiles marked code for the chip application, which reads programming language source code as input and which outputs source code in the same programming language, and another standard compiler for the host application, which reads programming language source code as input, but which generates executable code for the host platform. The implication of this scenario is that the resulting executable code must be launched on a host-platform, not on a chip platform.

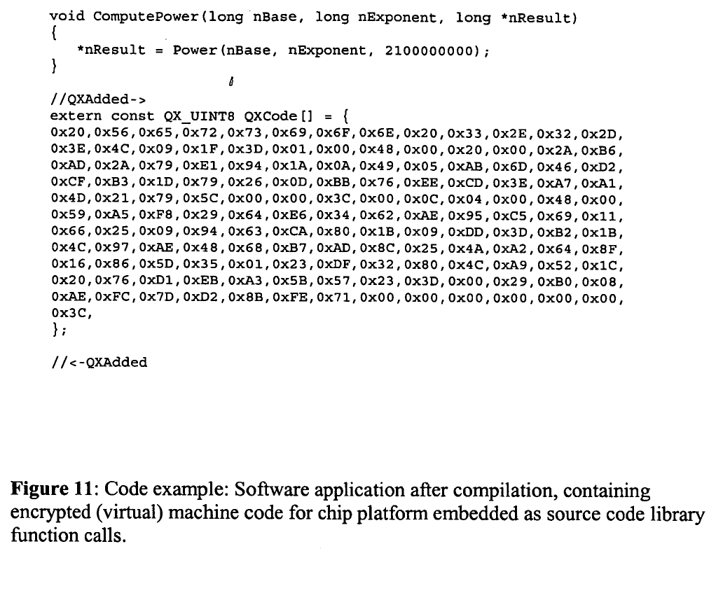

FIG. 11 shows the result of compiling the ANSI C programming language source code example of FIG. 10 using the chip (QX token) compiler shown in FIG. 8. The code in FIG. 11 is also according to the ANSI C programming language. The marked blocks have been compiled into (virtual) machine code for the target platform, then (in one embodiment) encrypted. The QXCode array defined at the end of the code in FIG. 11 contains these encrypted virtual machine code for the smart card operating system virtual machine. The marked blocks, and/or function calls to marked blocks containing a function, have been replaced by an anonymous API function call, which serves the purpose of relaying the (encrypted, virtual) machine code blocks to the destination platform, for subsequent storage and execution on the remote platform. The inserted function QXExecutePtr( ) causes, when executed, all its arguments to be relayed to the smart card chip. These arguments are, amongst other, the QXCode array containing the encrypted virtual machine code.

A significant advantage of using QX tags to mark code and let a compiler replace its contents with QXExecutePtr( ) style functions, is to alleviate the need for developers to program communication protocols. The task of programming for multiple processors is thereby greatly simplified.

The code in FIG. 11 may now be compiled using a commercially available compiler, e.g. Microsoft Visual C++ (indicated by the “Compile for host” arrow in FIG. 8), to obtain executable code for a Windows PC host platform (i.e. the “Host and chip executable code” shown in FIG. 8).

Notice that the mark-up tags (QXBegin-QXEnd) are enclosed within comments in FIG. 10. This allows the code to be compiled either for the host alone (by invoking only the host application compiler), or for the host and chip (by invoking the chip application compiler before the host application compiler). Ordinary compilers ignore comment fields. However, the chip compiler is constructed to be capable of parsing and understanding comment fields of a programming language. The advantage of hiding tags within comment fields is to allow the original (tagged) source code file(s) to be directly compilable by the “final” compiler in the chain (e.g. Microsoft Visual C++ in the example above). This standard compile-scheme is illustrated in FIG. 9. The advantage of allowing a direct compilation of all code for one platform, is to allow simulation and thereby facilitate testing and debugging of the application on just one platform. Now the developer does not need to learn new tools for debugging; but may use the debugging tools which he/she is already familiar with. If tags were not hidden, the source code would not be directly compilable by e.g. Microsoft Visual C++.

In addition to keywords to mark what code belongs to what platform, other keywords can be defined for various purposes: As an alternative to QXBegin QXEnd style marks, a singular mark (e.g. “QX”) can be defined to associate a single statement with a specific platform. Another mark “QXUpload” can instruct the compiler to include source code to the purpose of causing one, several or all QX blocks to be uploaded onto the device, without causing any of the QX blocks to be actually invoked. In the case that the execution of QX blocks is controlled by a software license or a capability, marks can be inserted to the effect of affecting the license or capability, e.g. incrementing a counter or setting a timestamp. Keywords may also contain arguments, e.g. QXBegin (PlatformId, LicenseId, AccessMode, Countdown). Here, the compiler may generate code to a) enforce the code to be executed on a specific, named platform, b) enforce conditional execution according to the capabilities given by a specific license, c) Supply an access mode to be verified against a license access mode, also allowing conditional execution, and d) changing the value of a counter.

In one embodiment of the present invention, execution of an application on a platform is controlled by a license residing securely within that platform. A license is equivalent to a capability. It contains attributes which define under what circumstances the applet may be uploaded to the card and/or executed. A license contains different attributes. A unique LicenseId associates uniquely with a specific applet. Other attributes include license limitations (from date/time, to date/time, number of executions, access modes for execution of groups of QX blocks), cryptographic keys, password/pin codes, various text description fields and so on. A license may for instance specify that QX blocks 1 and 4 of the associated applet may execute any number of times until 30. November. QX blocks 2 and 3 of the applet may not execute, and when the license expires on the 30. November, the card holder needs to acquire a new license to renew his rights to execute the applet.

Licenses can be moved from one token to another (provided the license issuer has set the attribute which allows the license to be moved). One token may typically be connected to an online (web) server, or the token functionality may be integrated with the web server itself. This allows other tokens to connect towards the server token and to acquire/purchase new licenses online. Since every license transfer takes place using secure cryptographic protocols, the confidentiality, integrity and license piracy issues are properly taken care of. Such a secure and convenient means for distributing licenses online, along with a secure and convenient means for distributing protected software applications online, facilitates new business opportunities for software rental.

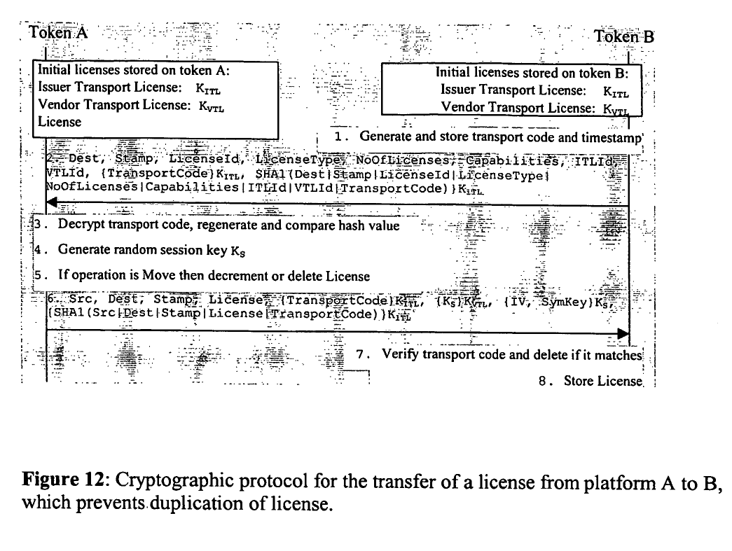

A cryptographic protocol used for the secure license transfer between tokens is described in FIG. 12. A license is transferred from token A to token B. The protocol ensures that the license is moved no more than once to the destination token, and never at all to any other token.

Letting token A act as a server token allows licenses to be distributed/checked out to client tokens, as described above. Letting a server token also act in the role of token B allows unused or partially used licenses to be returned to the server. This feature is useful e.g. in corporate license servers to allow licenses to be checked out and in, and thereby float from client to client where the license is required.

In FIG. 12, tokens A and B initially share the same (token issuer) transport license. The tokens may also share a vendor transport license. All transport licenses contain a symmetric key. Token A also holds the License which we want to move to token B. If the tokens do not share a common vendor transport license, the issuer transport license is used in its place. The protocol operates as follows: Token B generates a license request including a random transport code in step 1. In step 2 the license request is sent to token A. The license request is integrity protected. In step 3 token A verifies the integrity of the license request. If OK, the token proceeds to generate a session key in step 4. The license is prepared for transfer, the session key is encrypted with the vendor transport license as specified by the license request and the license is deleted from the license store in step 5. In step 6 the license is transmitted to destination token B. Some license attributes are confidentiality protected, notably the license cryptographic key, while the entire license is integrity-protected. In step 7 the transport codes are compared. This crucial step ensures that a license is moved once and only once to the right token, and never at all to any other token. If the transport codes match, token B replaces the license request (which contained the transport code) with the actual license in step 8.

Changes can be made to the embodiments described above without departing from the broad inventive concept thereof. The present invention is thus not limited to the particular embodiments disclosed, but is intended to cover modifications within the spirit and scope of the present invention.

1. A method of executing software code of a software program on an external unit, the software code being parsed into a plurality of different blocks of code, each block of code being independently executable, wherein the external unit is in communication with a computer, the computer including memory for holding the software code, the external unit including (i) input/output for communication with the computer, (ii) a processor, and (iii) memory, the method comprising:
(a) automatically uploading a first block of code to the memory of the external unit;
(b) executing the first block of code in the external unit using only the processor and the memory of the external unit; and
(c) sequentially and automatically uploading and executing the remaining blocks of code of the software code in the external unit, wherein subsequent blocks of code overwrite previously uploaded blocks of code in the memory of the external unit.

2. The method of claim 1 wherein the software code is a smart card application (applet), and each of the different blocks of code are functions or methods.

3. The method of claim 2 wherein the computer includes a plurality of software programs and applets, and steps (a) and (b) are performed for each applet.

4. The method of claim 1 wherein step (a) is performed in the computer at runtime of the software code.

5. The method of claim 1 wherein step (a) is performed prior to runtime of the software code.

6. The method of claim 1 wherein the software code includes a first portion and a second portion, the second portion being the software code having a plurality of different blocks of code, each block of code being independently executable, the method further comprising:
(d) executing the first portion of code in the computer.

7. The method of claim 1 wherein the software code is encrypted, the method further comprising:
(d) decrypting each block of code in the external unit prior to execution.

8. The method of claim 1 further comprising:
(d) after execution of the last block of code, the external unit sending back state information to the computer for subsequent use by at least the first portion of the software code.

9. The method of claim 1 wherein the external unit is a smart card.

10. A method of executing software code of at least one software program in a multi-processor computer environment, each software program including (i) a first portion of software code to be executed in a computer, and (ii) a second portion of software code to be executed in one or more external units which are in communication with the computer, the software code of the second portion being parsed into a plurality of different independently executable blocks of code, each external unit including (i) input/output for communication with the computer, (ii) a processor, and (iii) memory, the method comprising:
(a) automatically uploading a first block of code to the memory of an external unit at execution time of the second portion of software code;
(b) executing the first block of code in the external unit using only the processor and the memory of the external unit; and
(c) sequentially and automatically uploading and executing the remaining blocks of code of the software code in the external unit, wherein subsequent blocks of code overwrite previously uploaded blocks of code in the memory of the external unit.

11. The method of claim 10 wherein the second portion of software code is a smart card application (applet), and each of the different blocks of code are functions or methods.

12. The method of claim 11 wherein the software program includes a plurality of applets interspersed within the software program, and steps (a)-(c) are performed for each applet.

13. The method of claim 10 wherein the second portion of software code is encrypted, the method further comprising:
(d) decrypting each block of code in the external unit prior to execution.

14. The method of claim 10 further comprising:
(d) after execution of the software code, the external unit sending back state information to the computer for subsequent use by at least the first portion of software code.

15. The method of claim 10 wherein the external unit is a smart card.

16. A method of preparing software code of a software program to be executed on an external unit which is in communication with a computer, the computer including memory for storing the software code, the method comprising parsing the software code into a plurality of different blocks of code which can be sequentially uploaded to, and independently executed in, the external unit.

17. The method of claim 16 wherein the software code is a smart card application (applet), and each of the different blocks of code are functions or methods.

18. The method of claim 16 wherein the software program includes (i) a first portion of software code to be executed in the computer, and (ii) a second portion of software code to be executed in the external unit which is in communication with the computer, and only the second portion of software code is parsed into a plurality of different blocks of code which can be sequentially uploaded to, and independently executed in, the external unit.

19. A method of preparing a source code program comprising creating pre-compiled source code from original source code, wherein at least a portion of the pre-compiled source code is source code having a function call with arguments that are encrypted machine code, and the pre-compiled source code has the same language syntax as the original source code.

20. The method of claim 19 wherein the pre-compiled source code includes interspersed first and second portions of pre-compiled source code, only the second portions being source code having a function call with arguments that are encrypted machine code.

21. A method of preparing protected computer code from original source code of a software program, the original source code including interspersed first portions and second portions of code of the software program, the method comprising creating a pre-compiled version of the original source code by:
(a) transforming each second portion into a function call with arguments that are encrypted executable machine code; and
(b) copying each first portion to the pre-compiled version,
the pre-compiled version of the original source code having the same language syntax as the original source code.

22. The method of claim 21 wherein each of the second portions of the original source code original block of code has an associated tag, and step (a) uses the tags to identify each second portion for transformation.

23. The method of claim 21 further comprising:
(c) re-compiling the precompiled version of the original source code into a single integrated executable machine code program having function calls which are associated with the encrypted executable machine code.

24. A method of executing one or more blocks of protected software code within a machine code program in a plural processor environment, each block of protected software code having a function call with arguments that are encrypted executable machine code, the method comprising:
(a) executing at least portions of the machine code program in a first processor; and
(b) upon reaching a function call for a block of protected software code, decrypting and executing the associated protected software code in a second processor.

25. The method of claim 24 wherein step (b) further comprises upon reaching a function call for a protected block of software code, sending the associated protected software code to the second processor for decryption and execution therein.

26. The method of claim 24 further comprising:
(c) upon initiation of step (a), uploading all of the blocks of protected software code to a memory associated with the second processor for subsequent decryption and execution therein upon reaching each of the respective function calls.

27. The method of claim 24 wherein the second processor is a smart card.
